(19) United States
(12) Patent Application Publication
(10) Pub. No.: US 2011/0009295 A1
(43) Pub. Date: Jan. 13, 2011

(54) SYSTEM, HEATING BLOCK AND METHOD

(75) Inventors: Emilio Rene Bodenstaff, Delft (NL); Adrianus Hendricus Joseph Franciscus de Keijzer, Hoogerheide (NL); Tom Nijbacker, Heiloo (NL)

Correspondence Address: HOFFMANN & BARON, LLP, 6900 JERICHO TURNPIKE, SYOSSET, NY, 11791, US

(73) Assignee: AVANTIUM INTERNATIONAL B.V., Amsterdam (NL)

(21) Appl. No.: 12/666,500

(22) PCT Filed: Jun. 27, 2007
(86) PCT No.: PCT/NL07/00162

§ 371 Date: Mar. 25, 2010

(51) Int. Cl. C40B 60/14; C40B 50/00; F28F 7/00

(52) U.S. Cl. 506/23; 506/40; 165/185

(57) ABSTRACT

The present invention provides a system, comprising at least one reactor array, comprising at least two reactor vessels (2) a connecting member for fixating the at least two reactor vessels relative to each other (4, 5) at least one reactor block (18) comprising a heating block (20) for heating the reactor vessels (2) the heating block (20) comprising at least two reactor channels for receiving the at least two reactor vessels (2) wherein the heating block (20) is constructed of a material having a thermal expansion coefficient <=1×10e−5 K-I (at 293K). In an embodiment the heating block is substantially entirely constructed of graphite.

### CROSS-REFERENCE TO RELATED APPLICATIONS

This application is the National Stage of International Application No. PCT/NL2007/000162, filed Jun. 27, 2007, the contents of which is incorporated by reference herein.

### FIELD OF THE INVENTION

The present invention relates to a system, a heating block and a method for using the system.

### BACKGROUND OF THE INVENTION

WO-02/053278 provides a system comprising multiple reactor vessels arranged in an array. The reactor vessels operate in parallel. The reactor is suitable for performing different reactions simultaneously. The reactor vessel array is placed in a temperature controlled block for controlling the temperature of the reactor vessels, for instance for heating the vessels. After finalizing a reaction, the reactor vessel array may be removed from the temperature controlled block and replaced with another reactor vessel array for performing subsequent reactions.

Although the above-mentioned system is beneficial for performing multiple reactions subsequently, the reactor vessel array may become stuck in the temperature controlled block upon raising the temperature. The system including the reactor vessel array must be cooled to be able to remove the reactor vessel array from the temperature controlled block. Cooling the system, removing and replacing the reactor vessel array, and subsequently heating the replaced reactor vessel array increases the time necessary to perform subsequent reactions.

All currently available systems comprising multiple reactor vessels arranged in an array pose the above-mentioned problem.

### SUMMARY OF THE INVENTION

The present invention aims to obviate the need to cool the system between subsequent reactions.

The invention therefore provides a system, comprising:

at least one reactor array, comprising:
at least two reactor vessels;
a connecting member for fixating the at least two reactor vessels relative to each other;

at least one reactor block, comprising a heating block for heating the reactor vessels, the heating block comprising at least two reactor channels for receiving the at least two reactor vessels,

wherein the heating block is constructed of a material having a thermal expansion coefficient <1×10e−5 K-1 (at 293K).

The system of the invention enables to replace the reactor vessel array for another reactor vessel array at elevated temperatures. Elevated temperatures include for instance temperatures up to 550, 900, or 1200 degree C. The system of the invention obviates cooling and heating between subsequent reactions. The system according to the present invention decreases the time needed to perform subsequent reactions.

All currently available heating blocks consist of a metal, mostly aluminum or silver. The reactor vessels are arranged in openings in the heating block at room temperature. When the heating block is subsequently heated, for instance to temperatures above 200 degree C., the metal of the heating block expands. The heating block expands to such an extent that the reactor vessels become wedged within the heating block and cannot be removed. Upon heating the heating block to a temperature of for instance 250 to about 300 degree C., the reactor vessels become stuck in the heating block.

When using the system of the invention, the reactor vessels can be removed from the heating block and replaced with another array of reactor vessels, even at temperatures above 300 degree C.

The use of an array of reactor vessels provides considerable advantages over the use of a single reactor vessel. The array of reactor vessels comprises at least two reactor vessels. The array may comprise any number of reactor vessels. An array of reactor vessels may be provided with a single gas connection for all reactor vessels of the array. The use of only a few connectors, for instance two screws and bolts, may already be sufficient to provide a gas or fluid tight closure of all the reactor vessels of the array. When using singular reactor vessels, each reactor vessel should be provided with a separate gas connection, and separate connectors. The use of arrays of reactor vessels considerably reduces the time needed to perform tests.

In an embodiment, the material of the heating block is non-metallic. The inventors found that the problem of the prior art systems is caused by the expanding metal of the prior art heating blocks. Surprisingly, all presently available heating blocks are constructed of metal, mostly aluminum or silver. The non-metallic heating block of the invention prevents wedging of the reactor vessels due to decreased thermal expansion of the heating block.

In another embodiment the material comprises graphite. Graphite is light weight, relatively inexpensive, and easy to machine.

In a further embodiment the material comprises ceramic. Ceramic is readily available, and is less expensive than a metal such as silver. The linear thermal expansion coefficient of a ceramic such as titanium dioxide is about 8.2×10⁻⁶ K⁻¹ at 293K.

In an embodiment, the heating block comprises a graphite block that is substantially entirely comprised of graphite. Graphite has a thermal expansion coefficient that is considerably lower than the thermal expansion coefficient of the material used in existing heating blocks. Silver, copper and aluminum are the most common materials for heating blocks. The thermal expansion coefficient alpha of graphite is about 7.8×10⁻⁶ K⁻¹ at 293K and about 8.9×10⁻⁶ K⁻¹ at 500K.

In contrast, the linear thermal expansion coefficient alpha of aluminum is about 24×10⁻⁶ K⁻¹ (at 293K). The linear thermal expansion coefficient of copper is about 18×10⁻⁶ K⁻¹ (at 293K) and the linear thermal expansion coefficient alpha of silver is about 18×10⁻⁶ K⁻¹ (at 293K).

The crystal structure of graphite comprises carbon molecules that are arranged in planes forming layers. In one embodiment the planes of the layers of the graphite extend in a length and a width direction of the heating block, i.e. perpendicular to the reactor channels. This is the preferred embodiment used in combination with pressurized reactor vessels, due to the improved transportation of heat along the layers of the graphite towards the reactor vessels. During the reactions, the reactor vessels of pressurized reactors are sealed and pressurized.

In another embodiment, planes of layers of the graphite extend in a height direction of the heating block, i.e. parallel to the reactor channels and the reactor vessels. This is the preferred embodiment used in flow reactors, wherein during the reactions the reactor vessels are open and are continuously fed with a reaction fluid. An additional advantage of this embodiment, contrary to metal heating blocks, is the improved heat distribution over the length of the reaction vessel. The latter is due to the higher thermal conductivity of the graphite along the planes of the layers, i.e., about 250 W/(m.K) at 273K along the planes of the layers, contrary to about 80 W/(m.K) at 273K in a direction perpendicular to the layers.

According to another aspect, the present invention provides a heating block suitable for a system as described above.

According to still another aspect, the present invention provides a method of using a system as described above.

### BRIEF DESCRIPTION OF THE DRAWINGS

Additional features and advantages appear from the enclosed drawings, wherein:

FIG. 1 shows a perspective view of a first embodiment of a system according to of the present invention;

FIG. 2 shows a perspective view of the heating block of the system of FIG. 1;

FIG. 3 shows a schematic side view of the first embodiment of the system of the present invention;

FIG. 4 shows a perspective view of a second embodiment of the system of the present invention;

FIG. 5 shows a schematic side view of the system of FIG. 4;

FIG. 6 shows a schematic side view of a reactor vessel of the system of FIG. 4; and

FIG. 7 shows a schematic side view of the heating block and a reactor vessel array of the system of FIG. 4.

### DETAILED DESCRIPTION OF PREFERRED EMBODIMENTS

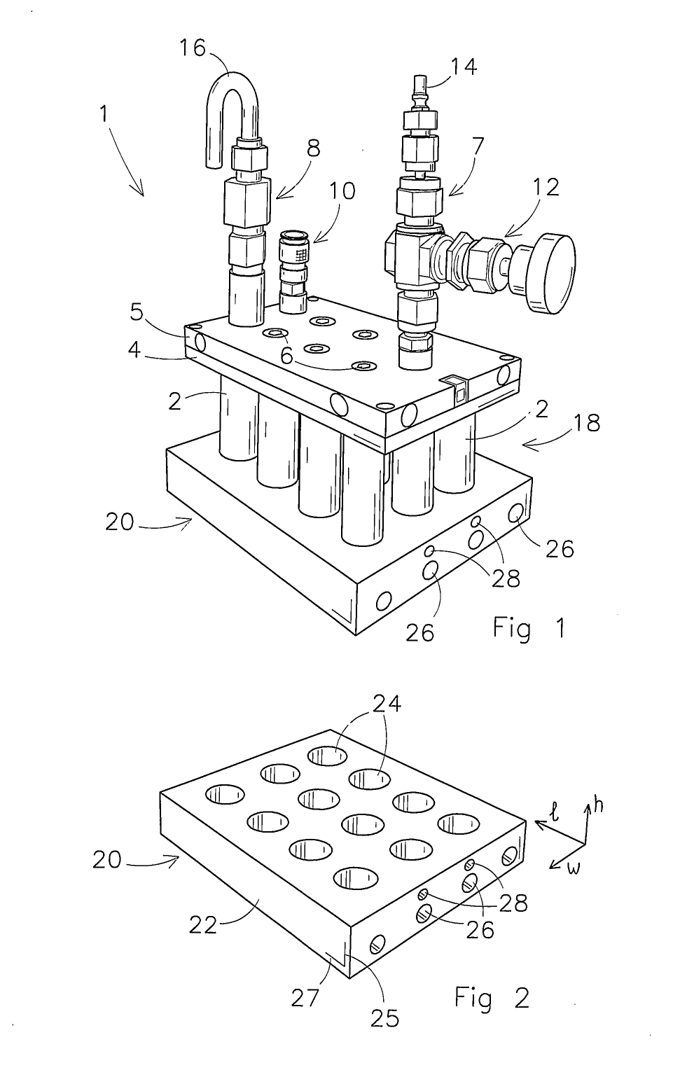

FIG. 1 shows a system 1 according to the present invention. The system 1 comprises a number of reactor vessels 2. The reactor vessels are arranged in a reactor array of, for instance, 3×4 reactor vessels 2. The reactor vessels 2 are at one end fixated in a connecting member, comprising for instance support plate 4 and closure plate 5. The connecting member is provided with suitable fixing means 6. Such fixing means are for instance described in WO-02/053278, which is in this respect incorporated by reference. The fixing means include for instance threaded openings, bolts and/or nuts. The closure plate 5 covers the support plate 4. The closure plate 5 functions for instance as a gas manifold, as a pressure plate, etc.

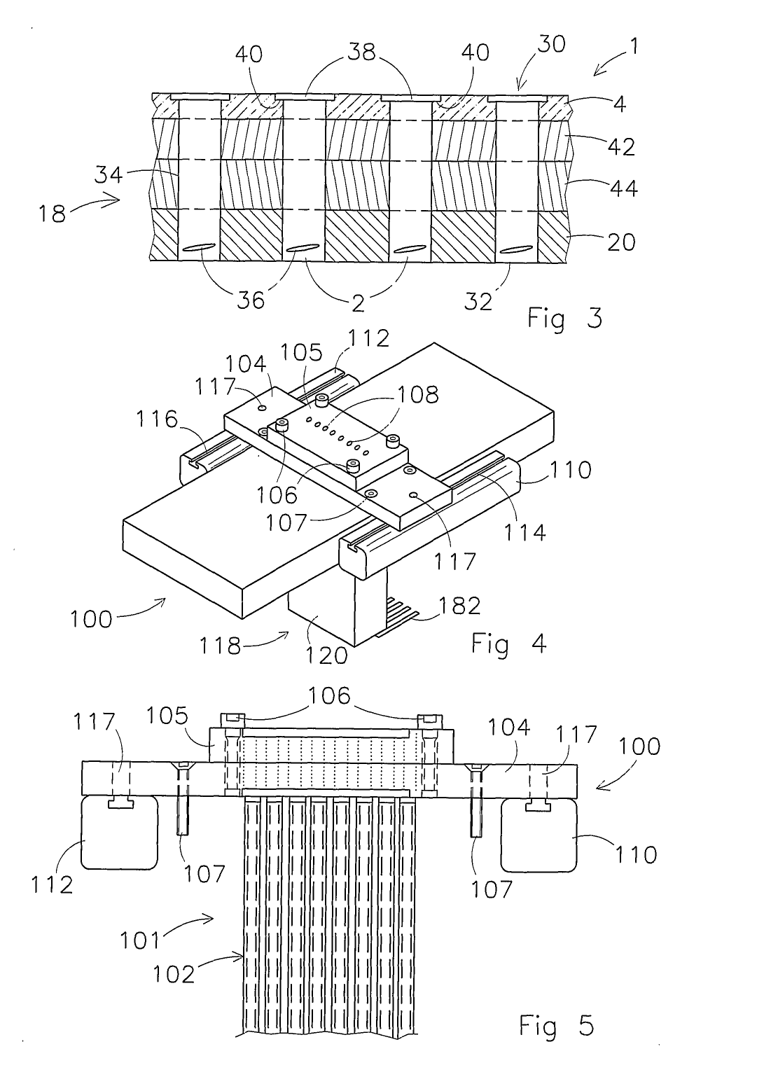

The reactor vessels 2 have an open end 30 and a closed end 32 (FIG. 3). In FIG. 1, the open end is the top end of the reactor vessels, and the closed end is the bottom end. In use, the closure plate 5 closes the open end 30. Preferably the connection between the closure plate 5 and the support plate 4 provides a gas and/or fluid tight closure of the reactor vessels 2.

The closure plate 5 is for instance provided with conduits 7, 8 and/or valve 12. The conduits 10, 14 are provided with suitable connectors. Tube 16 is the exit of a spring relief valve.

The system further comprises a reactor block 18 comprising various layers (FIG. 3) having desired characteristics. Reactor channels 24 for receiving the reactor vessels 2 are provided in the various layers of the reactor block. For instance, the closed ends 32 of reactor vessels 2 are arranged in the reactor channels 24 of heating block 20 (FIG. 2). The heating block 20 comprises a graphite block 22. Preferably, the graphite block is substantially entirely comprised of graphite. The graphite block 22 is relatively flat, i.e. the height h thereof is relatively small compared to its length 1 and width w.

One or more heating channels 26 are arranged in the heating block 20. The heating channels 26 extend in the direction of the length and/or the width of the heating block 20. One or more sensor channels 28 are arranged in the heating block. The sensor channels extend in the direction of the length and/or the width of the heating block 20.

Other arrangements of the respective channels are also conceivable. The reactor vessel, heating and/or sensor channels may for instance extend through the entire block 22. On the other hand, the respective channels may be blind holes, i.e. closed on one end.

The reactor channels 24 are cylinder shaped. The reactor channels have a diameter that corresponds to the outer diameter of the cylinder shaped reactor vessels 2.

As shown in FIG. 3, a magnetic stirring rod 36 is provided in the reactor vessels 2. In the vicinity of the reactor vessels, pairs of controllable magnets (not shown) are arranged. Four magnets are for instance provided in a square, at opposite sides of the closed ends 32 of the reactor vessels 2. Changing the polarity of the magnets in a controlled fashion will cause the stirring rods 36 to rotate and stir the contents of the respective reactor vessels.

The open ends 30 of the reactor vessels are provided with flanges 38. The support plate 4 is provided with openings 40 having a shape that corresponds to the outer shape of the reactor vessels and the flanges.

The reactor block 18 comprises for instance a cooling layer 42 and/or an insulating layer 44 that are arranged between the support plate 4 and the heating block 20. The cooling layer 42 and the insulating layer 44 comprise suitable materials for their respective functions, i.e. cooling and insulation. However, if other reactions should be carried out, the cooling layer 42 and/or insulation layer 44 may be omitted and/or changed into other layers that are suitable for the respective reactions.

Various reactions may be performed using the system 1. The closure plate 5 seals the open end of the reactor vessels 2. The magnetic stirring rods 36 are controlled to rotate as desired to stir the contents of the reactor vessels (FIG. 3). Heating elements (not shown) are introduced in the heating channels 26 and thermal sensors are introduced in the sensor channels 28. The heating elements preferably comprise a metal strip, which is connected to an electrical power source for heating the metal strip. The heated metal strips of the heating elements will heat the graphite block 20. The graphite subsequently conducts the heat to the reactor vessels 2.

To improve the heat conduction towards the reactor vessels 2, the heating block of the pressurized reactor 1 preferably comprises a graphite block 22. Planes of layers of the graphite may extend in the length and width direction of the heating block. As mentioned above, the heat conduction of graphite along the planes of the layers thereof is about three times higher than in a direction perpendicular to the planes of the layers. The planes of the graphite preferably have a configuration that is most suitable for the respective type of reactor or reaction.

Multiple reactor units, i.e. two, three or more, can be arranged adjacent to each other. Thus, the number of reactions that can be carried out simultaneously may be increased. The maximum number of simultaneous reactions is determined by the total number of reactor vessels.

In another embodiment (FIGS. 4, 5) the system 100 of the invention comprises a reactor array 101 comprising one, two or more reactor vessels 102. The reactor vessel array 101 comprises for instance a row of eight reactor vessels 102. Multiple rows of reactor vessels may be arranged adjacent to each other.

The reactor vessels 102 are at one end fixated in a connecting member, comprising for instance support plate 104 and connecting plate 105. The connecting member is provided with suitable fixing means 106, 107. Such fixing means are for instance described in WO-02/053278, which is in this respect incorporated by reference. The fixing means include for instance threaded openings, bolts and/or nuts. The connecting plate 105 covers the support plate 4. The connecting plate 105 is for instance provided with openings 108 that are aligned with the reactor vessels for inputting fluid or gas.

The support plate 104 is at its opposite ends supported by elongated beams 110, 112 of a guiding structure (FIGS. 4, 5). The beams 110, 112 are provided with grooves 114, 116 for slidably guiding extending cams 117 of the support plate 104.

The reactor vessels 102 are arranged in corresponding reactor channels 124 in a reactor block 118, comprising heating block 120. Corresponding herein indicates a shape that corresponds to the outer shape of the reactor vessels 102. The heating block 120 may provide a relatively tight fit to the reactor vessels 102, to improve heat conduction.

The heating block 120 preferably comprises a graphite block. Planes of layers of the graphite may extend along the length of the reactor vessels 102, i.e. in the height direction of the heating block 120 to improve the heat distribution along the reactor vessels.

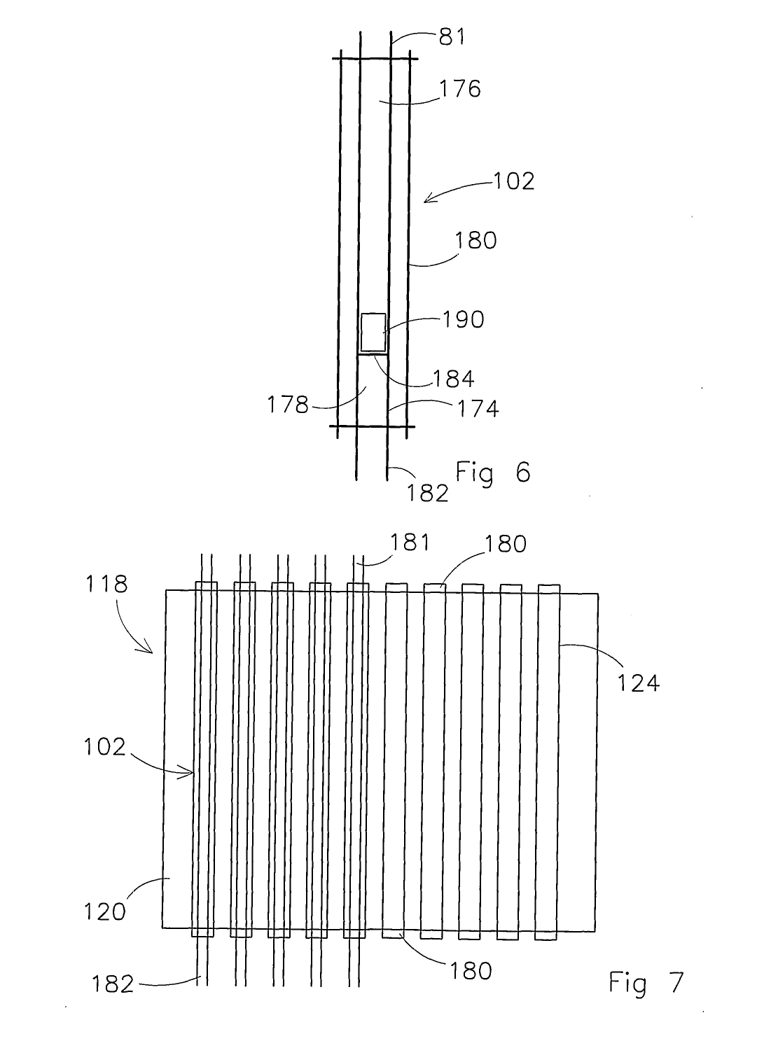

The reactor vessels 102 comprise cylinders 174 having an open end 176 and a fluid and/or gas permeable end 178 (FIG. 6). Along a certain length, the cylinders 174 may be provided with outer cylinders 180 (FIG. 7), i.e. the reactor vessels 102 may at least partly comprise a double wall.

Reaction fluid may be introduced into the reactor vessels 102 via conduits 181 through the open ends 176. The fluid and/or gas permeable end 178 is in fluid/gas communication with a fluid/gas conduit 182 for draining reaction products away from the reactor vessels. The fluid permeable end 178 may be provided with means, such as a filter or a mesh 184 (FIG. 6), for retaining catalyst 190. In an embodiment, cylinder 174, conduit 181 and conduit 182 are formed as a single tube.

In use, the ends 176 of the reactor vessels 102 (FIG. 6) are continuously supplied with a reaction fluid. The heating block 120 is heated, substantially corresponding to the heating of the heating block 20 of FIG. 1.

The reactor 100 of FIGS. 4-7 is denominated as a continuous flow reactor. As the catalyst 190 remains in the reactor vessels, exchange of the reactor vessels is obviated and the fit of the reactor vessels in the reactor channels 124 may be relatively tight.

Known continuous flow reactors comprise a heating block made of a metal, mostly silver or chromium. Silver and chromium are suitable for relatively high temperatures, up to 600 degree C. (silver) or 900 degree C. (chromium). However, the reactor vessels, and hence also the reactor channels, may differ for different kinds of reactions. The latter is especially true when performing reactions, i.e. tests, on demand, for instance for clients. The need for different reactor channels for a certain test requires the construction of a new heating block for the respective test. The construction of a new heating block made of silver or chromium is however time consuming and expensive.

The heating block 120 according to the present invention comprises for instance a graphite block. Construction of the graphite block is relatively fast and inexpensive. Machining the graphite block comprises cutting off a flat block of graphite and machining the respective openings therein. Heating elements for heating the heating block may be introduced in heating channels of the heating block.

The graphite is able to withstand high temperatures, for instance up to about 550, 900, or up to 1200 degree C. The heating block according to the present invention will provide a cost reduction when carrying out different reactions, and enable a wide temperature range.

The system of the present invention is for instance applicable in a laboratory setup. The system enables chemical scientists to screen a multitude of, for instance 96, batch reactions in parallel. The reactions may be performed on a scale of about 1 ml. The system is suitable for chemical process development and/or catalysis research.

The system allows investigating the effect of catalysts, solvents, temperature, and/or pressure for a broad range of batch chemistries. The chemical reactions may include, but are not limited to hydrogenations, oxidations, hydroformylations, carbonylations, coupling reactions and polymerizations. The system of the present invention is easy to use and requires only a small amount of precious starting material.

The present invention is not limited to the above described embodiments thereof; many modifications are imaginable within the scope of the enclosed claims.

1-18. (canceled)

19. A system, comprising:
at least one reactor array, comprising:
at least two reactor vessels;
a connecting member for fixating the at least two reactor vessels relative to each other;
at least one reactor block, comprising a heating block for heating the reactor vessels, the heating block comprising at least two reactor channels for receiving the at least two reactor vessels,
wherein the heating block is constructed of a material having a thermal expansion coefficient <1×10e−5 K-1 (at 293K).

20. The system of claim 19, wherein the material is non-metallic.

21. The system of claim 19, wherein the material comprises graphite.

22. The system of claim 19, wherein the material comprises ceramic.

23. The system of claim 19, wherein the heating block is substantially entirely constructed of graphite.

24. The system of claim 19,
wherein the heating block comprises at least one heating channel for receiving a heating element,
wherein the heating element is adapted for heating the heating block.

25. The system of claim 24, wherein the at least one heating channel extends in a width and/or a length direction of the heating block.

26. The system of claim 24,
wherein the at least one heating element comprises a metal strip, and
wherein the heating element is connected to an electrical power source for heating the metal strip.

27. The system of claim 19, wherein the at least two reactor channels extend in a height direction of the heating block.

28. The system of claim 21, wherein planes of layers of the graphite extend in a length and a width direction of the heating block.

29. The system of claim 23, wherein planes of layers of the graphite extend in a length and a width direction of the heating block.

30. The system of claim 21, wherein planes of layers of the graphite extend in a height direction of the heating block.

31. The system of claim 23, wherein planes of layers of the graphite extend in a height direction of the heating block.

32. The system of claim 19, comprising pairs of opposing magnets that are arranged at an underside of the heating block, near the at least two reactor channels,
wherein the pairs of magnets are controllable for rotating a magnetic rotation device within the at least two reactor vessels.

33. The system of a claim 19,
wherein the at least two reactor channels extend through the heating block;
wherein the at least two reactor vessels comprise a fluid permeable end for retaining catalyst, and an open end for introducing a reaction fluid into the reactor vessels;
the system comprising at least one conduit in fluid communication with said fluid permeable end of the at least one reactor vessel.

34. The system of claim 33, wherein the fluid permeable end comprises a filter.

35. The system of claim 19, wherein the heating block comprises at least one sensor channel for receiving a thermal sensor.

36. The system of claim 19, comprising two or more adjacent reactor units, each reactor unit comprising a reactor array and a reactor block.

37. A heating block, suitable for a system according to claim 19.

38. Method of using a system according to claim 19.
